(19) United States
(12) Patent Application Publication
(10) Pub. No.: US 2019/0032610 A1
(43) Pub. Date: Jan. 31, 2019

(54) FRESH AIR SUPPLY SYSTEM FOR AN INTERNAL COMBUSTION ENGINE OF A MOTOR VEHICLE

(71) Applicant: Mahle International GmbH, Stuttgart (DE)

(72) Inventors: Tobias Baumgart, Winterbach (DE); Winfried Brand, Stuttgart (DE); Wolfgang Gueth, Stuttgart (DE)

(21) Appl. No.: 16/072,880

(22) PCT Filed: Jan. 26, 2017
(86) PCT No.: PCT/EP2017/051654

§ 371 Date: Jul. 25, 2018

(30) Foreign Application Priority Data
Jan. 26, 2016 (DE) 10 2016 201 078.6

(51) Int. Cl. F02M 35/10; F02D 9/10; F02B 27/02

(52) U.S. Cl. CPC F02M 35/10065; F02D 9/106; F02D 9/1095; F02M 35/10085; F02B 27/0273; F02D 9/107

(57) ABSTRACT

A fresh air supply system may include a housing that may include an upper housing part and a lower housing part and delimiting a housing interior. The system may also include at least one bearing part arranged in the housing interior and a shaft at least partially arranged and rotatably mounted in the at least one bearing part. The at least one bearing part, in a cross-section of the housing perpendicular to a rotation axis of the shaft, may be structured in a pot-like manner including a pot base. The lower housing part may include a lower housing part extension resting against a projection of the pot base such that a clamping connection is formable. The upper housing part may include at least one upper housing part extension which the at least one bearing part may rest against.

### CROSS-REFERENCE TO RELATED APPLICATIONS

This application claims priority to International Patent Application No. PCT/EP2017/051654, filed on Jan. 26, 2017, and German Patent Application No. DE 10 2016 201 078.6, filed on Jan. 26, 2016, the contents of both of which are hereby incorporated by reference in their entirety.

### TECHNICAL FIELD

The invention relates to a fresh air supply system for an internal combustion engine of a motor vehicle and a motor vehicle with such a fresh air supply system.

### BACKGROUND

A fresh air supply system for internal combustion engines is usually understood to mean a device which serves for the introducing of fresh air into one or more combustion chambers of the internal combustion engine. In a supercharged internal combustion engine, a compression or respectively compacting of the fresh air takes place within the fresh air supply system, for example by means of an exhaust gas turbocharger.

With regard to the effectiveness of the combustion processes taking place in the combustion chambers, an adaptation of the air mass flow, flowing through the fresh air supply system, to an instantaneous rotation rate of the internal combustion engine is of critical importance. Modern fresh air supply systems are therefore often equipped with a flap mechanism, by means of which the duct cross-section of the fresh air path which is present in the fresh air supply system can be varied and therefore the air mass amount flowing in a particular time interval through the fresh air path can be adjusted. Such a flap mechanism typically comprises one or more flaps which are fastened in a torque-proof manner on a common shaft. Said shaft is, in turn, mounted rotatably on a housing of the fresh air supply system.

DE 10 2012 203 232 A1 concerns a fresh gas distributor for an internal combustion engine, with a shaft which is arranged between a bearing plate and individual bearing blocks. The bearing plate is connected here directly here to an intake module upper part. The bearing blocks form a counter bearing, which are inserted into corresponding mounts provided on the bearing plate.

EP 0 726 388 A1 concerns an intake system for an internal combustion engine, in which the shaft of a flap mechanism is mounted directly between an upper housing part and a lower housing part.

In such conventional fresh air supply systems, the relatively high installation cost on assembly proves to be problematic. Furthermore, with a direct mounting of the shaft between the upper housing part and the lower housing part, small tolerance variations can only be achieved with a very high installation cost, because precisely the typically large-volume upper housing part is subject to high tolerance variations. Particularly during cooling of the housing parts, which are typically configured as plastic injection moulded parts, a mechanical distortion can occur, which as a result can lead to a jamming of the shaft mounted between the housing parts.

### SUMMARY

It is therefore an object of the present invention to provide an improved embodiment of a fresh air supply system, in which the above-mentioned problems no longer occur or, at the most, occur in reduced form.

This problem is solved by the subject of the independent claim(s). Preferred embodiments are the subject of the dependent claim(s).

Accordingly, it is a basic idea of the invention to realize the mounting of a shaft as part of a flap mechanism of a fresh air supply system by means of an additional bearing part—in addition to an upper housing part and a lower housing part of the housing—, which can be fixed in a two-part housing by means of a clamping connection. Such a three-part structure permits a simple assembly of the fresh air supply system. At the same time, tolerance variations in the positioning of the shaft in the housing can be kept small, whereby a precise positioning of the shaft can be ensured.

A fresh air supply system according to the invention for an internal combustion engine of a motor vehicle comprises a housing, which has an upper housing part and a lower housing part and delimits a housing interior. The connection between the upper housing part and the lower housing part can be configured so as to be detachable or non-detachable. Depending on the variant, the upper housing part and the lower housing part can be screwed, glued, welded, rivetted or clipped to one another. Therefore, the bearing part is arranged fixedly between the upper housing part and the lower housing part and is able to be mounted as a structural unit on the cylinder head of the internal combustion engine or on the accordingly corresponding structural unit.

The housing interior serves here as a fresh air duct for the air which is to be directed through the fresh air supply system. In the housing interior, a shaft is arranged, which is mounted so as to be rotatable relative to the housing. According to the invention, at least one bearing part is arranged in the housing interior, on which bearing part the shaft is rotatably mounted.

In a preferred embodiment, the shaft is arranged between the bearing part and the lower housing part. This permits a precise mounting of the shaft in the housing interior, before subsequently the two housing parts are fastened to one another to complete the assembly.

Expediently, the bearing part can be braced between the upper housing part and lower housing part to form a clamping connection. This provision permits a fixing of the bearing part with small tolerance variations in the housing interior which is simple to realize and nevertheless mechanically precise.

In an advantageous further development, at least one extension, protruding towards the lower housing part, is formed on the upper housing part in a cross-section of the housing perpendicularly to a rotation axis of the shaft. The bearing part rests against this extension for clamping between upper housing part and lower housing part. The extension serves for the formation of said clamping connection as pressure point onto the bearing part.

According to an advantageous further development, a plurality of extensions are arranged at a distance from one another, in a top view onto an underside of the upper housing part facing the housing interior. These extensions protrude from the upper housing part away towards the bearing part. This provision brings about an improved clamping of the bearing part on the housing. Preferably, the extensions are configured in a pin-like manner.

A particularly uniform clamping effect over the entire bearing part can be achieved when the extensions are arranged on a first longitudinal side and on a second longitudinal side of the upper housing part lying opposite the first longitudinal side.

Particularly preferably, a recess, formed in a complementary manner to the extension, is provided on the bearing part for each extension formed on the upper housing part, into which recess the respective extension can engage. This facilitates the mounting of the upper housing part on the lower housing part with, at the same time, the formation of a clamping connection of the bearing part to the two housing parts.

According to another preferred embodiment, the bearing part is arranged in the region of the at least one extension, formed on the upper housing part, at a distance from the lower housing part. Such a provision is accompanied by an improved clamping effect of the upper housing part onto the bearing part.

A particularly precise positioning of the shaft in the housing interior can be achieved by a recess being provided in the bearing part, in which recess the shaft can be at least partially, preferably completely, received.

In a further advantageous realization form, the bearing part is formed in the cross-section of the housing perpendicularly to the rotation axis of the shaft in a pot-like manner with a pot base and with a pot collar protruding from the pot base towards the lower housing part. In this variant, the pot base rests against the lower housing part for clamping between the upper housing part and the lower housing part. By means of such a pot-like configuration, it can be ensured that the bearing part only requires a little installation space in the housing interior, so that the latter is available as a fresh air channel for fresh air. The pot base is preferably arranged at a distance from the upper housing part.

Meanwhile, little installation space is required by an advantageous further development of the invention in which the pot base in the cross-section of the housing faces the upper housing part perpendicularly to the rotation axis of the shaft, and has on the side pointing towards the lower housing part the recess for receiving the shaft.

Particularly preferably, the pot collar is arranged at a distance from the lower housing part. In this way, a particularly good clamping effect of upper housing part and lower housing part onto the bearing part can be ensured.

In another preferred embodiment, the pot base has in the cross-section a projection protruding towards the lower housing part, in which projection the recess is arranged. In this way, a precise positioning of the shaft on the bearing part, and therefore in the housing interior, can be realized.

In a further preferred embodiment, a lower housing part extension, protruding towards the bearing part, is formed on the lower housing part, which extension rests on the pot base, in particular on the projection formed on the pot base. This provision brings about a particularly good clamping effect of the lower housing part onto the bearing part.

Particularly preferably, the lower housing part extension is formed such that it closes the recess with the shaft received therein. In this way, the shaft can be mounted so as to be rotatable in a particularly stable manner in the bearing part.

A particularly stable mechanical fastening of upper housing part and lower housing part to one another can be achieved by the upper housing part being equipped, in the cross-section of the housing perpendicularly to the rotation axis of the shaft, with a radially outwardly protruding flange portion, which is welded to the lower housing part.

In a further advantageous further development of the invention, at least two bearing parts are present, which are arranged, along an axial direction defined by the rotation axis of the shaft, adjacent and preferably at a distance to one another. This simplifies the assembly of the housing in fresh air supply systems for internal combustion engines having several cylinders, which requires a shaft having several adjusting flaps. In this scenario, the individual bearing parts which are present can be inserted successively into the housing interior, before the shaft is mounted as a unit on all inserted into the housing interior.

Particularly expediently, the bearing part is not welded to the upper housing part, because the clamping connection formed between the bearing part and the upper housing part or respectively lower housing part proves to be entirely sufficient for the precise mounting of the shaft in the housing interior. The omission of said welded connection therefore leads to not inconsiderable cost advantages in the production of the fresh air supply system.

The invention further relates to an internal combustion engine having a fresh air supply system explained above. The advantages, explained above, of the fresh air supply system are therefore transferred to the motor vehicle.

Further important features and advantages of the invention will emerge from the subclaims, the drawings and the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained further in the following description, wherein the same reference numbers refer to identical or similar or functionally identical components.

### BRIEF DESCRIPTION OF THE DRAWINGS

There are shown, respectively diagrammatically

FIG. 1 an example of a fresh air supply system according to the invention for an internal combustion engine of a motor vehicle,

FIG. 2 a detail illustration of FIG. 1 in the region of the bearing part,

FIG. 3 the housing with the upper housing part and the housing part and bearing part and shaft in an exploded illustration.

### DETAILED DESCRIPTION

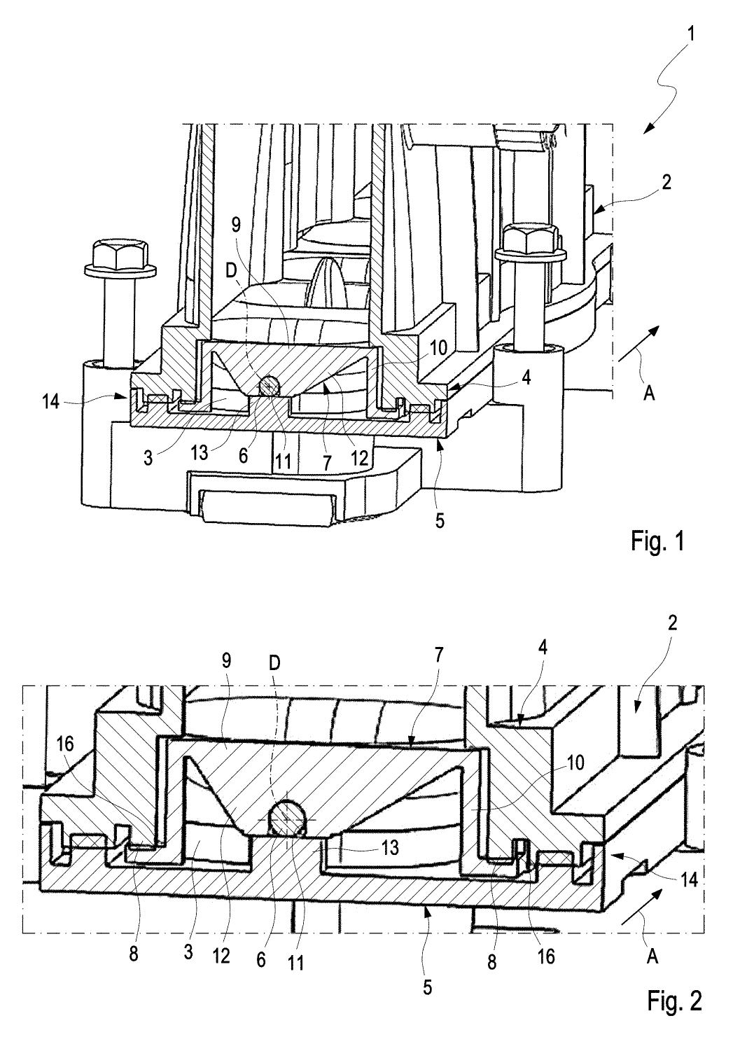

FIG. 1 shows an example of a fresh air supply system 1 according to the invention for an internal combustion engine of a motor vehicle. The fresh air supply system 1 comprises a housing 2, which has an upper housing part 4 and a lower housing part 5 and delimits a housing interior 3. The housing interior 3 forms a fresh air duct for air which is to be directed through the fresh air supply system 1. In the housing interior 3 a shaft 6 is mounted so as to be rotatably adjustable relative to the housing 2. The mounting of the shaft 6 takes place by means of a bearing part 7 which is likewise arranged in the housing interior 3. For this, the shaft 6 is arranged between the bearing part 7 and the lower housing part 5. The bearing part 7 is fastened to the housing 2 by means of a clamping connection and, for this, is braced between upper housing part 4 and lower housing part 5.

FIG. 1 shows a cross-section of the housing 2 perpendicularly to a rotation axis D of the shaft 6. In the cross-section of the housing 2 shown in FIG. 1, the bearing part 7 is configured in a pot-like manner with a pot base 9 and a pot collar 10 protruding from the pot base 9. For mounting the shaft 6, a recess 11 is present in the pot base 9 of the bearing part 7, in which recess the shaft 6 is held rotatably relative to the bearing part 7 and therefore also to the housing 2. In the cross-section, the pot base 9 faces the upper housing part 4, nevertheless preferably arranged at a distance thereto, and has a projection 12 protruding towards the lower housing part 5, in which projection said recess 11 is provided with the shaft 6.

In the cross-section of the housing 2 illustrated in FIG. 1, an extension 8 is formed on the upper housing part 4, protruding towards the lower housing part 5. By means of this extension 8, the bearing part 7 rests on the upper housing part 4 for the formation of the clamping connection or respectively for clamping between the upper housing part 4 and the lower housing part 5. On the other hand, the bearing part 7 is arranged at a distance from the lower housing part 5 in the region of the extension 8 formed on the upper housing part 4.

On the lower housing part 5, in turn, a lower housing part extension 13 is formed, protruding towards the bearing part 7, which lower housing part extension rests against the projection 12 of the pot base 9 of the bearing part 7 for the bracing of the bearing part 7 between the upper housing part 4 and the lower housing part 5, and, in so doing, closes the recess 11.

The pot base 9 of the bearing part 7 therefore rests by means of the projection 12 against the lower housing part extension 13 of the lower housing part 5. The pot collar 10 of the bearing part 7, on the other hand, is arranged at a distance from the lower housing part 5, but, in turn, rests against the extension 8 of the upper housing part 4. The pot base 9, as already mentioned, is preferably arranged at a distance from the upper housing part 4.

For the fixing of upper housing part 4 and lower housing part 5 to one another, the upper housing part 4 in the cross-section of FIGS. 1 and 2 has a flange portion 14 protruding radially outwards, away from the housing interior 3, which flange portion is welded to the lower housing part 5. The bearing part 7, on the other hand, is welded neither to the upper housing part 4 nor to the lower housing part 5.

Rather, the bracing/clamping, explained above, of the bearing part 7 between the upper housing part 4 and the lower housing part 5 is entirely sufficient for fixing the bearing part 7 in the housing interior 3.

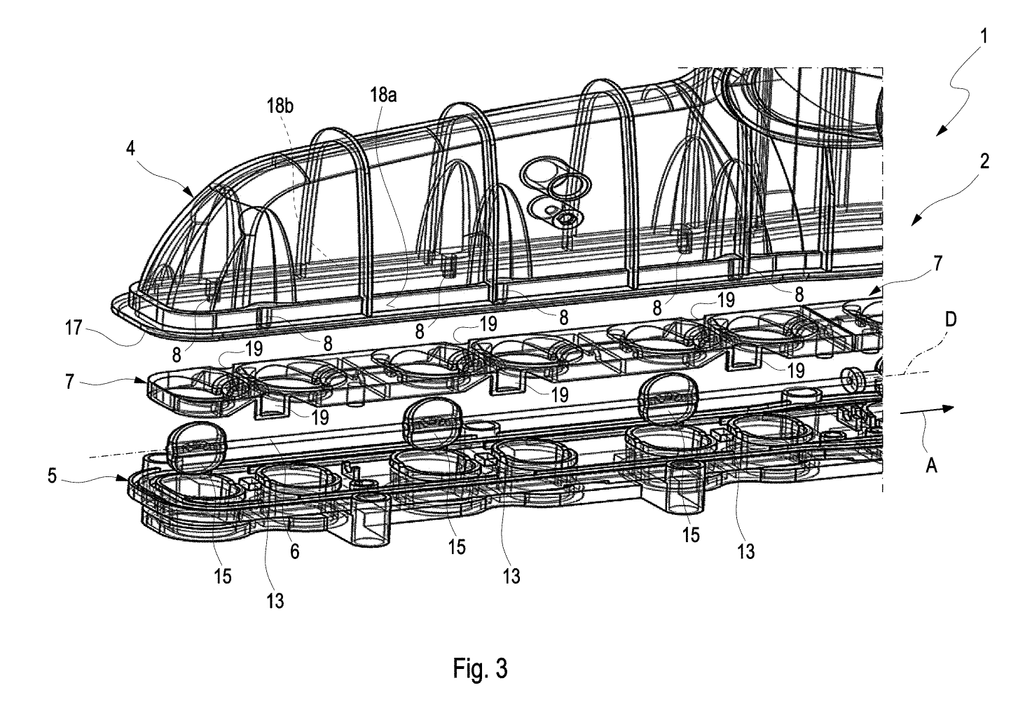

FIG. 3 shows the housing 2 with the upper housing part 4 and the lower housing part 5 and with shaft 6 in an exploded illustration. In FIG. 3, the flaps 15 can be seen, fastened in a torque-proof manner to the shaft 6, of a flap mechanism of the fresh air supply system 1 formed of shaft 6 and flaps 15. Furthermore, it can be seen from FIG. 3 that the fresh air supply system 1 can have not only a single bearing part 7, but rather that several bearing parts 7 can be present, which are arranged at a distance and adjacent to one another along an axial direction A defined by the rotation axis D of the shaft 6. In FIG. 3, by way of example, two such bearing parts 7, arranged with respect to one another, are shown.

According to FIG. 3, in a top view onto an underside 17 of the upper housing part 4 facing the housing interior 3, several extensions 8 are arranged at a distance to one another. The extensions 8 are preferably configured in a pin-like manner. The extensions 8 are arranged on a first longitudinal side 18a and on a second longitudinal side 18b of the upper housing part 4 lying opposite the first longitudinal side 18a, and protrude away from the upper housing part 4 towards the bearing part 7. For each extension 8 formed on the upper housing part 4, a recess 19 is present on the bearing part 7, said recess being formed in a complementary manner to the extension 8, into which recess the respective extension 8 can engage.

1. A fresh air supply system for an internal combustion engine of a motor vehicle, comprising:
a housing including an upper housing part and a lower housing part and delimiting a housing interior;
a shaft arranged in the housing interior and mounted rotatably relative to the housing;
at least one bearing part arranged in the housing interior, the shaft at least partially arranged and rotatably mounted in the at least one bearing part;
the at least one bearing part, in a cross-section of the housing perpendicular to a rotation axis of the shaft, structured in a pot-like manner including a pot base and a pot collar protruding from the pot base;
the pot base resting against the lower housing part such that the at least one bearing part is clampable between the upper housing part and the lower housing part;
the pot base, in the cross-section of the housing, including a projection protruding towards the lower housing part, the projection including a recess;
the lower housing part including a lower housing part extension protruding towards the at least one bearing part and resting against the projection such that a clamping connection is formable; and
the upper housing part, in the cross-section of the housing, including at least one upper housing part extension protruding towards the lower housing part, the at least one bearing part resting against the at least one upper housing part extension such that the at least one bearing part is clampable between the upper housing part and the lower housing part;
wherein the at least one bearing part is arranged at a distance from the lower housing part in a region of the at least one upper housing part extension.

2. The fresh air supply system according to claim 1, wherein the shaft is arranged between the at least one bearing part and the lower housing part.

3. The fresh air supply system according to claim 1, wherein the at least one bearing part is braced between the upper housing part and the lower housing part to form the clamping connection.

4. The fresh air supply system according to claim 1, wherein the at least one upper housing part extension includes a plurality of upper housing part extensions arrange on an underside of the upper housing part which faces the housing interior, the plurality of upper housing part extensions arranged at a distance from one another and protruding away from the upper housing part towards the at least one bearing part.

5. The fresh air supply system according to claim 4, wherein the plurality of upper housing part extensions are arranged on a first longitudinal side of the upper housing part and on a second longitudinal side of the upper housing part lying opposite the first longitudinal side.

6. The fresh air supply system according to claim 4, wherein the at least one bearing part includes a plurality of recesses structured complimentary to the plurality of upper housing part extensions, each of the plurality of recesses configured to engage a respective one of the plurality of upper housing part extensions.

7. The fresh air supply system according to claim 1, wherein the at least one bearing part includes a shaft recess in which the shaft is at least partially arranged.

8. The fresh air supply system according to claim 1, wherein the pot base, in the cross-section of the housing, faces the upper housing part and includes a shaft recess configured to receive the shaft.

9. The fresh air supply system according to claim 1, wherein the pot collar is arranged at a distance from the lower housing part such that the clamping connection is formable.

10. The fresh air supply system according to claim 1, wherein the lower housing part extension closes the recess of the projection.

11. The fresh air supply system according to claim 1, wherein the upper housing part has, in the cross-section of the housing, a flange portion protruding radially outwards, and wherein the flange portion is welded to the lower housing part.

12. The fresh air supply system according to claim 1, wherein the at least one bearing part includes at least two bearing parts arranged adjacent and at a distance to one another along an axial direction defined by the rotation axis of the shaft.

13. The fresh air system according to claim 1, wherein the at least one bearing part is not welded to the upper housing part.

14. An internal combustion engine comprising a fresh air supply system including:
a housing including an upper housing part and a lower housing part and delimiting a housing interior;
a shaft arranged and rotatably mounted in the housing interior;
at least one bearing part arranged in the housing interior, the shaft at least partially arranged and rotatably mounted in the at least one bearing part;
the at least one bearing part, in a cross-section of the housing perpendicular to a rotation axis of the shaft, structured in a pot-like manner including a pot base and a pot collar protruding from the pot base;
the pot base resting against the lower housing part such that the at least one bearing part is clampable between the upper housing part and the lower housing part;
the pot base, in the cross-section of the housing, including a projection protruding towards the lower housing part, the projection including a recess;
the lower housing part including a lower housing part extension protruding towards the at least one bearing part and resting against the projection such that a clamping connection is formable; and
the upper housing part, in the cross-section of the housing, including at least one upper housing part extension protruding towards the lower housing part, the at least one bearing part resting against the at least one upper housing part extension such that the at least one bearing part is clampable between the upper housing part and the lower housing part;
wherein the at least one bearing part is arranged at a distance from the lower housing part in a region of the at least one upper housing part extension.

15. The internal combustion engine according to claim 14, wherein the shaft is arranged between the at least one bearing part and the lower housing part.

16. The internal combustion engine according to claim 14, wherein the at least one bearing part is braced between the upper housing part and the lower housing part to form the clamping connection.

17. The internal combustion engine according to claim 14, wherein the at least one upper housing part extension includes a plurality of upper housing part extensions arrange on an underside of the upper housing part which faces the housing interior, the plurality of upper housing part extensions arranged at a distance from one another and protruding away from the upper housing part towards the at least one bearing part.

18. The internal combustion engine according to claim 17, wherein the at least one bearing part includes a plurality of recesses structured complimentary to the plurality of upper housing part extensions, each of the plurality of recesses configured to engage a respective one of the plurality of upper housing part extensions.

19. The internal combustion engine according to claim 14, wherein the at least one bearing part includes a shaft recess in which the shaft is at least partially arranged.

20. A fresh air supply system for an internal combustion engine of a motor vehicle, comprising:
a housing including an upper housing part and a lower housing part and delimiting a housing interior;
a shaft arranged and rotatably mounted in the housing interior;
at least one bearing part arranged in the housing interior, the shaft at least partially arranged and rotatably mounted in the at least one bearing part;
the at least one bearing part, in a cross-section of the housing perpendicular to a rotation axis of the shaft, structured in a pot-like manner including a pot base and a pot collar protruding from the pot base;
the pot base resting against the lower housing part such that the at least one bearing part is clampable between the upper housing part and the lower housing part;
the pot base, in the cross-section of the housing, including a projection protruding towards the lower housing part, the projection including a recess;
the lower housing part including a lower housing part extension protruding towards the at least one bearing part and resting against the projection such that the recess of the projection is closed and a clamping connection is formable; and
the upper housing part, in the cross-section of the housing, including at least one upper housing part extension protruding towards the lower housing part, the at least one bearing part resting against the at least one upper housing part extension such that the at least one bearing part is clampable between the upper housing part and the lower housing part;
wherein the at least one bearing part is arranged at a distance from the lower housing part in a region of the at least one upper housing part extension; and
wherein the clamping connection is provided when that at least one bearing part is braced between the upper housing part and the lower housing part.
